(19) United States
(12) Patent Application Publication
(10) Pub. No.: US 2025/0060253 A1
(43) Pub. Date: Feb. 20, 2025

(54) BALER THERMAL SCANNING

(71) Applicant: Deere & Company, Moline, IL (US)

(72) Inventors: Umesh B. Jadhao, Pune (IN); Mohan A. Vadnere, Pune (IN)

(21) Appl. No.: 18/451,543

(22) Filed: Aug. 17, 2023

(51) Int. Cl. G01J 5/00; A01F 15/07; A01F 15/08

(52) U.S. Cl. CPC G01J 5/0003; A01F 15/07; A01F 15/08; G01J 2005/0077

(57) ABSTRACT

A method for identifying thermal conditions of components of a baler assembly that includes obtaining thermal data of an internal compartment of the baler assembly from a thermal sensor coupled to the baler assembly within the internal compartment, evaluating the thermal data with an evaluation system to determine thermal properties of the internal compartment and providing a feedback when the thermal properties are outside of a thermal threshold.

### FIELD OF THE DISCLOSURE

The present disclosure relates to a baler assembly and more specifically to identifying the thermal properties of components of a baler assembly.

### BACKGROUND OF THE DISCLOSURE

Bales of crop are typically formed by a tractor drawn harvesting machine including, near its leading edge, a pickup device in the form of a rotor having a plurality of outwardly extending tines. Rotor rotation serves to pick the crop upwardly over the rotor and rearwardly relative to a direction of travel for further processing. A comb-like array of fixed elements strip the crop from the tines at an appropriate location to prevent the crop from being returned to the ground. A pickup or take-up device with a wide swath is desirable to minimize the number of harvester passes necessary to clear a field. However, directly feeding the crop from such a wide swath to a baling chamber would result in an inordinately long and difficult to handle bales. Some type of converging arrangement for narrowing the width of the crop entering the baling chamber is typically employed to minimize the bale width.

Known large round balers receive the crop to be baled from a take-up device of great width that delivers it to a transverse conveyor, such as a screw conveyor, that conducts it in turn selectively into a cutter head from which it reaches a baling chamber or a pre-compression chamber.

Common baler assemblies are frequently exposed to high loads and friction points during a bale-forming operation. The thermal properties of certain components of a baler assembly may change during operation. There is a need for a system and method for monitoring the thermal properties of a baler assembly and providing feedback in view thereof, among other things.

### SUMMARY

One embodiment is a method for identifying thermal conditions of components of a baler assembly. The method includes obtaining thermal data of an internal compartment of the baler assembly from a thermal sensor coupled to the baler assembly within the internal compartment, evaluating the thermal data with an evaluation system to determine thermal properties of the internal compartment and providing a feedback when the thermal properties are outside of a thermal threshold.

In one example of this embodiment, the thermal sensor comprises one or more of a thermal camera, an infrared sensor, a resistance temperature detector, a thermistor, or a semiconductor temperature sensor. In another example, the thermal sensor comprises a thermal camera. In yet another example, the thermal data has data from a second thermal sensor spaced from the thermal sensor within the internal compartment. The second thermal sensor is spaced from the thermal sensor on an opposite side of the internal compartment and configured to provide thermal data for at least one of the components of the baler assembly on the opposite side of a bale when a bale is being formed therein.

Yet another example of this embodiment includes storing the thermal data in a database as historical thermal data and identifying a thermal trend in the historical thermal data and generating a second feedback based on the thermal trend. As part of this example, the second feedback comprises a maintenance suggestion when the thermal trend is within a trend threshold.

In yet another example of this embodiment, the feedback has an audio, visual, or sensory output. Part of this example includes providing the feedback through a user interface in a cab of a work machine.

Another example of this embodiment includes providing the feedback when the baler assembly is transitioned to a parked configuration. Yet another example includes evaluating position data provided by a positioning sensor and providing position recommendations with the feedback. Part of this example includes considering prior bale locations before providing position recommendations.

In yet another example of this embodiment, the thermal data has one or more of thermal properties for a roller and thermal properties for a bale. In another example, the thermal sensor is configured to detect the presence of a bale in the internal compartment. As part of this example, the feedback comprises stopping a baling procedure when the bale temperature data is outside of a bale temperature threshold.

In yet another example of this embodiment, the thermal data comprises an image and the thermal threshold corresponds with colors in the image. In another example, the thermal data has temperature values.

Another embodiment of this disclosure is a baler assembly that has a plurality of rollers spaced about an internal compartment and configured to form a bale therein and a thermal sensor positioned within the internal compartment and configured to provide thermal data for components of the baler assembly to an evaluation system. The thermal data is evaluated by the evaluation system to determine thermal properties of the internal compartment and provide a feedback when the thermal properties are outside of a thermal threshold.

In one example of this embodiment, the thermal sensor is a thermal camera. In another example, a user interface provides the feedback. In yet another example, a second thermal sensor provides thermal data for components of the baler assembly from a different perspective than the thermal sensor.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side section view of a conventional baler assembly;

FIG. 2 is a section side view of another embodiment of a baler assembly;

FIG. 3 is a schematic view of an evaluation system;

FIG. 4 is a logic flow chart of a thermal evaluation;

FIG. 5 is a logic flow chart for identifying bale locations from the baler assembly of FIG. 2; and

FIG. 6 is a visual representation of thermal image data considered for this disclosure.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

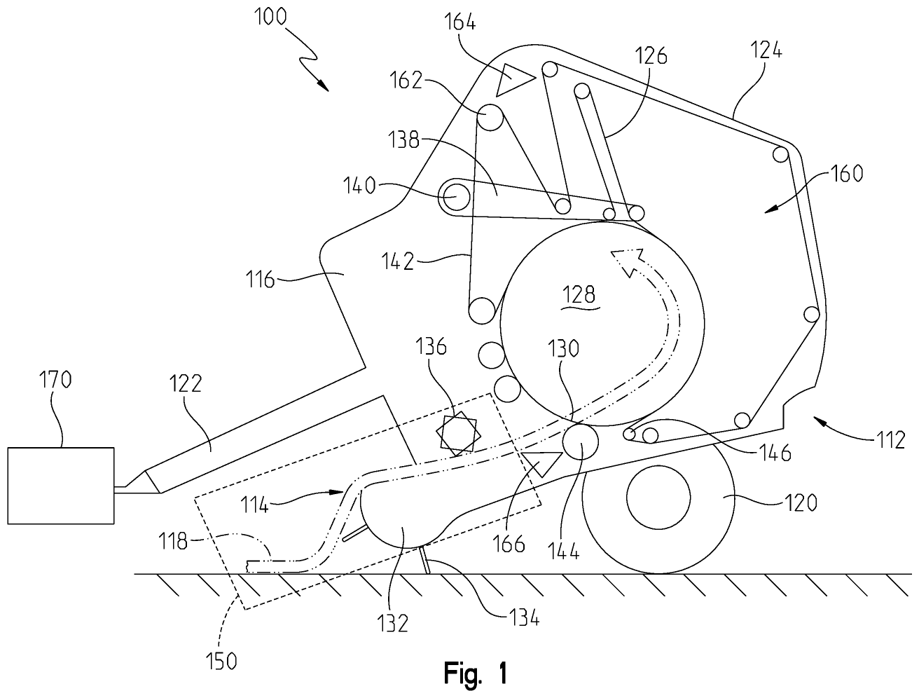

Referring to FIG. 1, a baler assembly 100 is illustrated having a chassis 112 and a pickup assembly 150. The pickup assembly 150 may have a crop supply assembly 114 among other things. The baler assembly 100 is configured as a large round baler, however, this disclosure may apply to rectangular balers as well. Further still, this disclosure contemplates applying the teachings discussed herein to any crop consolidation and binding machine. More specifically, this disclosure contemplates applying the teachings presented herein to round module building assemblies for cotton, among other things.

The baler assembly 100 is applied on the field and takes up crop 118 deposited on the ground in wide swaths, in order to subject it to a baling process. In the case of a large round baler, a configuration with a baling chamber of fixed size as well as a chamber of variable size can be considered. The baling chamber is located in an internal compartment of the baler assembly 100. The internal compartment 160 may be the area within side walls and one or more perimeter wall in which a bale 128 may be formed. Generally, the internal compartment 160 may be the area where many internal components of the baler assembly 100 are positioned to form a round bale 128 and where the round bale 128 is positioned before being ejected from the baler assembly 100. The “internal components” may refer to one or more of rollers, bearings, belts, rockshaft arms and pivots, bales being formed therein, wrapping systems, and any other known structure that is located in the internal compartment of a typical baling assembly and susceptible to thermal variations during use.

The chassis 112 includes a frame 116 supported on wheels 120, a tow bar 122, side walls 124, and a baling arrangement 126. An axle forms the connection between the wheels 120 and the frame 116 and can be attached or configured as spring-supported or rigid. The wheels 120 support the frame 116 on the ground so that it can move freely and be drawn across the field by the tow bar 122 due to its connection with a towing vehicle or other work machine 170. Alternatively, the baler assembly 100 may be integrated into a work machine wherein a single chassis contains the baler assembly 100 and the prime mover, drive train, and cab of a work machine. Accordingly, the teachings of this disclosure are contemplated as being applied to any type of baler assembly 100 whether the baling assembly is towed behind a work machine or integrated into the work machine.

The side walls 124 of the baler assembly 100 are spaced away from each other by the width of, and define opposite sides of, the internal compartment 160. The baling arrangement 126 may have belts, pulleys, bar chains or the like, and is used to take up the crop to be baled and conducted in the internal compartment and to compress it. An inlet 130 into the internal compartment 160 is provided at the forward lower end region of the baling arrangement 126. The pickup assembly 150 is composed of components that are located upstream of the inlet 130 and includes a take-up device 132. As crop is fed in, the bale expands and arm 138 pivots about axis 140 correspondingly increasing the portion of belt 142 surrounding the bale. The take-up device 132 is provided with tines 134 that raise the crop 118 to be baled from the ground and deliver it to the rear to the crop processing arrangement 136. The floor roller 144 is a tube and may be in front of a lower gate roller 146. Further rollers 162 may be positioned throughout the internal compartment 160 to provided support and guidance to the belts 142 among other things.

Rollers 162 may be any rolling component of the baler assembly 100 that facilitates movement of belts of the baling arrangement 126 around the bale 128 or that otherwise facilitates rolling of the bale 128 in the internal compartment 160 while being formed. A person skilled in the art understands that many baler assemblies utilize rollers and belts to form a bale therein. While FIG. 1 illustrates one specific example of a baler assembly 100, this disclosure contemplates applying the teachings presented herein to other configurations utilizing rollers or other moving components to form a bale or module.

In one aspect of this disclosure, the internal compartment 160 may have one or more thermal sensor 164, 166 positioned therein. The thermal sensors 164, 166 may be specifically positioned to capture thermal data for one or more of the rollers 162, the bale 128, or other internal components within the internal compartment 160 of the baler assembly 100. The thermal sensors 164, 166 may be thermal cameras, infrared thermal sensors, resistive temperature detectors, thermistors, or semiconductors among other known sensors capable of capturing thermal data. Further, the sensors 164, 166 may each be a different type of sensor relative to one another. Accordingly, this disclosure considers using any known type of thermal sensor, or combination thereof, for the thermal sensors 164, 166 along with using more than two thermal sensors and using only one thermal sensor.

In one aspect of this disclosure, the thermal sensors 164, 166 are positioned to monitor thermal conditions of the internal components in the internal compartment 160 that are susceptible to thermal variation during use. More specifically, the thermal sensor 164 may be positioned on an upper section of the baler assembly 100 in the internal compartment 160 to be directed towards rollers 162 on and around the expanding arm 138. In this configuration, the thermal sensor 162 may provide thermal data regarding the temperatures of rollers 162 and the like on and around the arm 138. However, any other location for the thermal sensor 164 in the internal compartment 160 is also contemplated herein.

The thermal sensor 166 may be positioned on a lower portion of the baler assembly 100 in the internal compartment 160 and configured to provide thermal data for internal components within the internal compartment 160 that may not be observable by the thermal sensor 164 when a bale 128 is being formed therein or otherwise. In one example, thermal sensor 166 may be positioned to monitor the thermal properties of rollers 162 around the inlet 130 such as the floor roller 144 and lower gate roller 146 among other rollers 162 and components at, or around, the inlet.

Further, one or both of the sensors 164, 166 may be positioned to provide thermal data regarding the temperature of the bale 128 being formed therein during a bale forming process. In this configuration, the thermal sensor 164, 166 may identify the thermal properties of the bale 128 being formed therein which in turn can be interpreted to identify whether a bale is currently in the baling chamber. The term “thermal properties” used throughout is referring to the temperature of the component, bale, or area immediately around the component or bale.

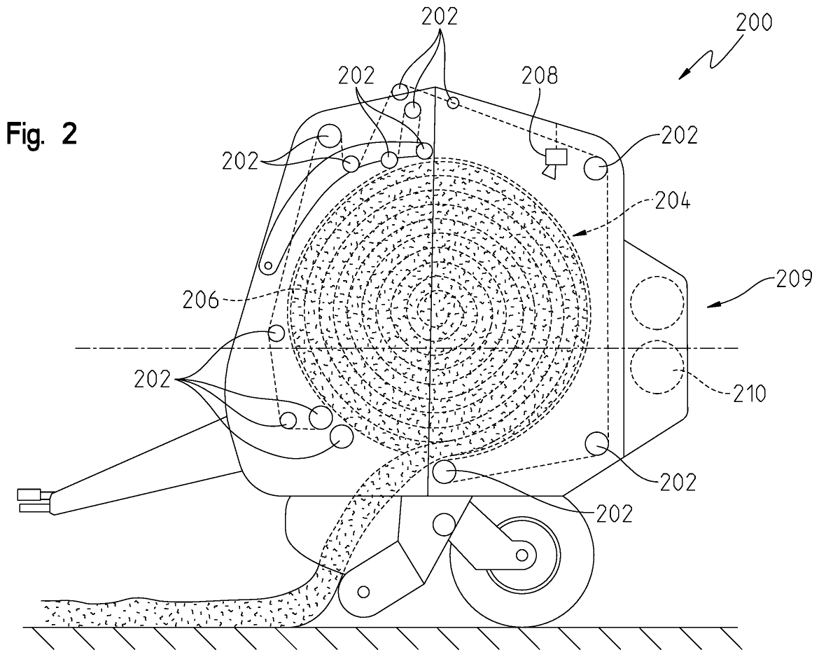

FIG. 2 illustrates another embodiment of a baler assembly 200 having a plurality of rollers 202 defined in an internal compartment 204. The plurality of rollers 202 may direct one or more belt about a bale forming cavity configured enlarge as a bale 206 is formed therein. The baler assembly 200 is another embodiment of a baler assembly that may position thermal sensors 208 in the internal compartment 204 to provide thermal data about components of the baler assembly 200 within the internal compartment 204. The baler assembly 200 may include a wrapping assembly 209 configured to store and providing a wrapping material 210 that is applied around the bale 206 when fully formed within the internal compartment 204. The thermal sensor 208 may also be positioned within the internal compartment 204 to identify thermal properties of any portions of the wrapping assembly 209 in the internal compartment 204.

The baler assemblies 100, 200 are embodiments of baler assemblies that can implement the teachings of this disclosure. However, this disclosure contemplates applying the teachings provided herein to any crop baling or module building machine that may generate heat during use. A person skilled in the art understands the many different types of baling assemblies for which the thermal sensors and teachings of this disclosure can be applied and the specific mechanical configurations of baler assemblies 100, 200 presented herein are meant as examples thereof. This disclosure contemplates applying the teachings presented herein to other baler configurations as well.

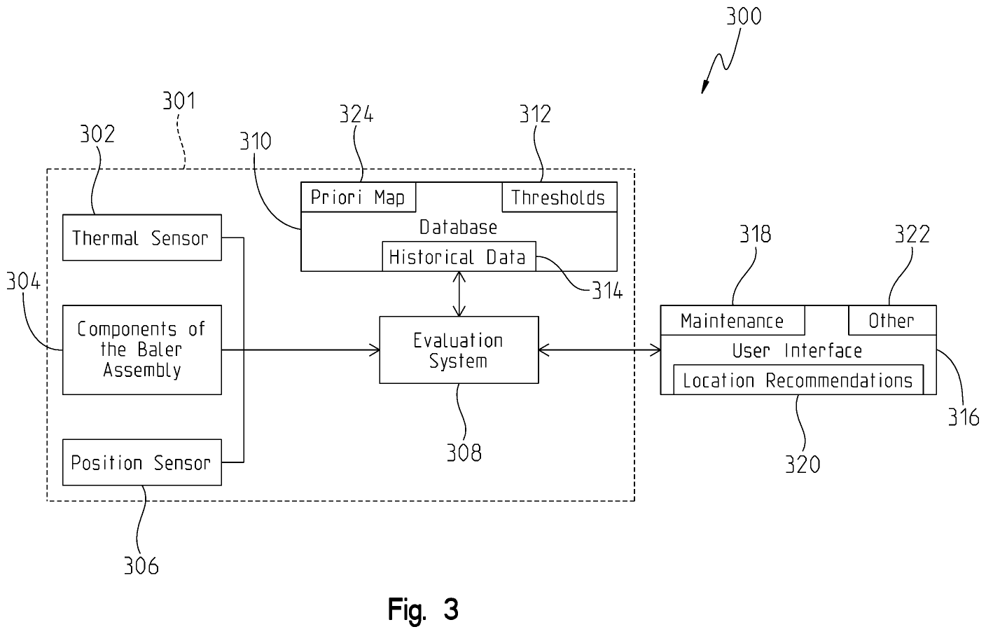

Referring now to FIG. 3, a schematic diagram 300 of the components of a baler assembly 301 of this disclosure are illustrated. The baler assembly 301 is representative of any baler assembly having internal components configured to form a bale. More specifically, the schematic diagram 300 illustrates components of this disclosure that may be applied or otherwise observed from any baler assembly to implement the teachings herein. The baler assembly 301 may be the baler assemblies 100, 200 discussed herein or a different baler assembly that has one or more of the components illustrated in the schematic diagram 300. For example, the baler assembly 301 may have one or more thermal sensor 302 such as the thermal sensors 164, 166, and 208, discussed herein. The baler assembly 301 may also have other components 304 therein, such as rollers and components in the internal compartment 160, 204 that facilitate forming a bale 128, 206.

The other components 304 may also include data provided from the work machine 170 regarding the operating conditions of the work machine 170. In one example, the other components 304 are identifiable by an evaluation system 308 and may include the drive position of the work machine 170. In one contemplated configuration, the other components 304 communicated to the evaluation system 308 include the drive state of the work machine 170. More specifically, the evaluation system 308 may identify when the work machine 170 is in a drive condition, where the work machine 170 can move about the underlying surface, and a park condition, where the work machine 170 does not substantially move along the underlying surface. The other components 304 considered by the evaluation system 308 may also include any sensor or input data provided by the work machine 170. More specifically, the evaluation system 308 may communicate with a control module of the work machine 170 such that any of data captured by the control module of the work machine 170 may be considered by the evaluation system 308.

The baler assembly 301 may also have a position sensor 306. The position sensor 306 may be any sensor known in the art and capable of identifying a geographic location of the position sensor 306. In one embodiment, the position sensor 306 may be incorporate a Global Positioning System (“GPS”). Alternatively, the position sensor 306 may utilize local markers to determine geographic position. This disclosure contemplates utilizing any known type of sensor that can identify a geographic location for the position sensor 306.

The position sensor 306 may be positioned in the baler assembly 301, as illustrated in FIG. 3, or position data may be provided from a different source. More specifically, position data may be provided from a position sensor 306 located on the work machine 170 pulling the baler assembly 301 rather than directly on the baler assembly 301. Regardless, the position data provided by the position sensor 306 may be such that that the geographic location of the baler assembly 301 can be determined in view thereof.

The thermal sensor 302 and position sensor 306 may provide corresponding data to the evaluation system 308. The evaluation system 308 may be a controller or the like that has one or more processor capable of reading and writing data and access to a memory unit capable of storing data. The controller for the evaluation system 308 may be coupled to the baler assembly 301 or the work machine 170 pulling the baler assembly 301. Alternatively, the evaluation system 308 may be located remotely from the baler assembly 301 wherein the data from the thermal sensor 302 and position sensor 306 is wirelessly communicated to the evaluation system 308 for further processing. In other words, this disclosure contemplates using any known hardware component capable of executing the processes and steps discussed herein as part of the evaluation system 308.

The evaluation system 308 may have access to one or more database 310. The database 310 may be a local memory unit in communication with a controller of the evaluation system 308. Alternatively, the database 310 may be a remote storage system such as a cloud database that the evaluation system 308 can access remotely. Regardless, the database 310 may be any known data storage system capable of storing and providing data.

In one aspect of this disclosure, the database 310 may have threshold values 312 stored therein. The threshold values 312 may correspond with temperature thresholds identified by the thermal sensor 302 or position data provided by the position sensor 306, among other things. The database 310 may also store historical data 314 provided to the evaluation system 308 from one or more of the thermal sensor 302 or the position sensor 306 among other sources. The historical data 314 may be further analyzed or processed by the evaluation system 308 as discussed herein.

The database 310 may also contain a priori map 324. The priori map 324 may contain one or more of a field map, altitude information, bale drop positions in the field, and moisture data among other geographic and environmental data for the surrounding area. The evaluation system 308 may utilize the priori map 324 to determine appropriate park positions for the baler 301 based on thermal data from the thermal sensor 302 and the priori map 324.

In yet another aspect of this disclosure, the evaluation system 308 may communicate with, or otherwise send signals to, a user interface 316. The user interface 316 may be a display, speaker, light, or other component in the cab of the work machine 170 configured to provide a signal to a user. In this example, the evaluation system 308 may have a wired or wireless communication link to the components in the cab of the work machine 170 to selectively send signals thereto to be observed by a user in the cab. Alternatively, the user interface 316 may be located remotely from the baler assembly 301. In one aspect of this disclosure, the user interface 316 may be a remote user device, such as a computer, smartphone, tablet, or any other known wired or wireless computing device. In this configuration, the evaluation system 308 may communicate wirelessly with the user interface 316 using any known wireless protocol, such as Bluetooth, Wi-Fi, local wireless networks, or other similar wireless protocols. Alternatively, the user interface 316 may be a dedicated display on the baler assembly 301. Regardless, this disclosure contemplates providing feedback regarding anticipated or needed maintenance 318, parking location recommendations 320, or other information 322 such as current temperatures of internal components and the bale, among other things.

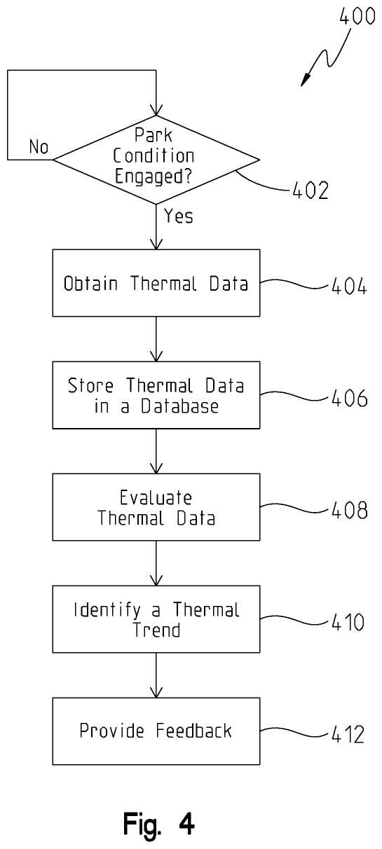

Referring now to FIG. 4, one example of a logic flow chart 400 of the present disclosure is illustrated. More specifically, the logic flow chart 400 may be implemented by the evaluation system 308 via one or more controllers associated therewith. Further still, the logic flow chart 400 may be stored on a memory unit of the evaluation system 308 or in the database 310. Regardless, the logic flow chart 400 is executable by the evaluation system 308 and considering one or more of the thermal sensor 302, other components 304 of the baler assembly 301, and the position sensor 306 discussed herein.

In one example, the logic flow chart 400 may be initiated when a park condition is engaged in box 402. The park condition may be identified by the evaluation system 308 through the other components 304 of the work machine 170 monitored by the evaluation system 308. For example, the evaluation system 308 may receive a signal when the work machine 170 is transitioned to a park condition wherein a prime mover of the work machine 170 is not coupled to drive wheels or the like such that the work machine 170 will not move along the underlying surface. If a park condition is not identified, in box 402, the logic flow chart 400 may continue to monitor the other components 304 until a park condition is identified. Once a park condition is identified, the evaluation system may obtain thermal data in box 404.

While one embodiment of this disclosure contemplates first identifying a park condition in box 402 before executing the remaining portions of the logic flow chart 400, this disclosure contemplates an embodiment that does not monitor for a park condition as well. In this embodiment, the logic flow chart 400 may substantially continuously execute boxes 404, 406, 408, 410, 412 in a cyclic or continuous manner instead of requiring a park condition of box 402 first.

Regardless, in box 404 the evaluation system 308 may obtain thermal data from the at least one thermal sensor 302. The provided thermal data may be temperature readings, thermal images, or any other thermal data known to be producible through a thermal sensor. In one contemplated embodiment, the at least one thermal sensor 302 is a thermal camera that provides a thermal image such as the thermal image data 600 illustrated in FIG. 6. The thermal image data 600 may provide observable discolorations 602a, 602b, 602c on an image to indicate the temperature of components shown therein. In one aspect of this disclosure, the evaluation system 308 may be capable of processing the thermal image data 600 to determine the thermal characteristics of the internal components shown therein. Alternatively, the thermal data obtained by the evaluation system 308 may be data produced by one or more thermal sensors 302 that are one or more of an infrared sensor, a resistance temperature detector, a thermistor, or a semiconductor temperature sensor, among others. In one aspect of this disclosure the evaluation system 308 may obtain data from a plurality of thermal sensors 302 simultaneously. Further still, the plurality of thermal sensors 302 may include different combinations of the types of thermal sensors discussed herein.

As the thermal data is being obtained, the evaluation system 308 may store the thermal data in the database 310. More specifically, the thermal data obtained in box 404 may be tied to metadata and stored in a database in box 406. The thermal data and metadata stored in the database 310 may include the thermal data, such as a thermal image or temperature readings, along with metadata identifying one or more of the time the data was collected and the location identified by the position sensor 306 at the time the data was collected, among other things. The data and metadata may be stored in the database as historical data 314 in box 406 for later or simultaneous processing by the evaluation system 308 or otherwise be accessible to a user through the user interface 316.

In box 408, the evaluation system 308 may evaluate the thermal data. This evaluation may be executed in real-time as the thermal data is being obtained in box 404 and may also consider historical data 314 stored in the database 310. In one example, real-time thermal data may be evaluated in box 408 to determine the current thermal properties of components in the internal compartment of the baler assembly 301. Among other things, the real-time thermal data may identify the thermal conditions of one or more of the rollers 162, 202 in the internal compartment of the baler assembly 301. Further, the real-time thermal data may be used by the evaluation system 308 to identify the presence, and bale size, of any bale being formed therein.

In another contemplated application of this disclosure, historical thermal data 314 may also be evaluated in box 408. The historical thermal data 314 may be the thermal data and metadata stored in the database 310 as historical data 314. The historical thermal data 314 may include prior-recorded thermal data and metadata such that the evaluation system 308 can compare the most recent thermal data to historical thermal data. In one aspect of this disclosure, the evaluation system may evaluate historical thermal data 314 to determine a thermal trend in box 410. More specifically, the database 310 may contain one or more threshold values 312 therein that are representative of expected temperature values or image coloration of the thermal data for the components located in the internal compartment of the baler assembly 301 under proper working conditions. The evaluation system 308 may compare one or more of the real-time thermal data and the historical data 314 with the thresholds 312 to identify thermal trends in the thermal data. For example, the evaluation system 308 may determine whether any of the internal components are heating up faster than expected under normal working conditions.

The thermal trends may include identifying when bearings are beginning to fail in one or more of the rollers. For example, acceptable temperatures to be expected for bearings of the rollers may be stored as thresholds 312 in the database 310. If the thermal data and trend identified in box 410 suggest that the thermal data for the bearing is trending towards exceeding the threshold, the evaluation system 308 may provide a second feedback in box 412 indicating a maintenance step is recommended. Similarly, threshold values for the expected thermal data for a bale being formed therein may be compared to the real-time or historical thermal data for the bale. In one example, the thresholds 312 contain threshold values for expected thermal trends for a bale forming in the internal compartment of the baler assembly 301. The threshold values 312 for the expected thermal trends for the bale may be compared the real-time and historical data 314 for the thermal properties of the bale over time. If the thermal properties for the historical data 314 of the bale being formed are not consistent with the thresholds 312, the evaluation system 308 may provide feedback to a user in box 412 identifying the discrepancy. In another contemplated embodiment, the evaluation system 308 may stop the bale forming process if a thermal sensor 302 indicates the bale is heating faster than expected when referencing the thresholds 312.

The feedback provided in box 412 may audible, visual, haptic, or otherwise. In one example contemplated herein, the user interface 316 may provide the feedback from box 412. As discussed herein, the feedback provided by the user interface 316 may come from a user interface mounted in a cab of the work machine 170. Accordingly, the feedback could be a light on a dashboard in the cab. Alternatively, the feedback could be a graphic illustrated on a screen in the cab. Further still, the feedback from box 412 may be a noise or haptic response provided to the user interface 316.

Alternatively the feedback from box 412 may be provided on a user interface coupled to the baler assembly 301 such as a screen, light, or speaker coupled to the baler assembly 301 that is capable of providing feedback to a user regarding the thermal conditions of the internal compartment of the baler assembly 301. Further still, the feedback provided in box 412 may be sent to a remote device such as a smartphone, tablet, computer, or any other remote computing device capable of wireless communication with the evaluation system 308.

In one aspect of this disclosure, the feedback provided in box 412 may provide an annotated priori map 324 that provides recommended parking locations for the baler based on the thermal data and the environmental and other conditions identified on the priori map 324. The feedback may be a visual representation of the priori map 324 showing geographic locations that are suitable for the baler 301 to be parked in given the thermal data among other things.

In use, the baler assembly 301 may execute the logic flow chart 400 either after a park condition is engaged in box 402, or substantially simultaneously when the baler assembly 301 is powered. Further, any recorded aspect of the other components 304 from the work machine 170 may be considered to trigger the flow chart 400. Further still, a user may initiate the flow chart logic through a user input on the user interface 316. Regardless, thermal data is provided from the thermal sensors 302 to identify the thermal conditions of the components in the internal compartment of the baler assembly 301. This disclosure contemplates altering the position, number, and type of thermal sensors 302 to ensure the components of the baler assembly 301 in the internal compartment most prone to thermal variance during use are monitored.

In one example contemplated herein, there are two thermal sensors 302 and the thermal sensors 302 are thermal cameras. The thermal cameras are directed to provide a perspective of the internal compartment from opposing sides of a bale being formed therein. In this configuration, a majority of the internal compartment of the baler assembly 301 may be observed by the thermal sensors 302 to provide thermal data on the internal components. The data provided by the thermal cameras may be the thermal image data 600 illustrated in FIG. 6. In this example, the evaluation system 308 may process the thermal image data 600 to determine whether the thermal image data 600 indicates whether any of the components in the internal compartment are operating with temperatures above predefined or generated thresholds 312. Further, the thermal image data 600 may be stored in the database 310 as historical data 314. Alternatively, any number or type of other thermal sensor 302 may be used to monitor the components of the internal compartment to provide the thermal data to be compared to the thresholds 312 and used for the historical data 314.

The thermal data provided by the at least one thermal sensor 302 may then be evaluated to determine whether any of the internal components or bale of the internal compartment are operating outside of the expected thresholds 312. In one example, the at least one thermal sensor 302 is positioned to identify the thermal properties of one or more rollers in the internal cavity to determine the temperature of bearings that support the rollers. Further still, the at least one thermal sensor 302 may be positioned to provide thermal data regarding the temperature of the bale being formed therein. When the at least one thermal sensor 302 is a thermal camera, a single thermal image may provide thermal data for both the bale and the rollers and bearings in the image. In this configuration, the evaluation system 308 may distinguish between the thermal data provided from the bale and the thermal data provide from the rollers and bearings.

Once the thermal data is provided, the evaluation system 308 may do one or both of compare the thermal data to the thresholds 312 stored in the database 310 or save the thermal data as historical data 314 to evaluate thermal trends. For example, if the thermal data indicates a roller or bearing is providing a temperature reading that is outside of a threshold 312, the user interface 316 may provide feedback indicating that is the case. Further, the historical data 314 of a particular roller may be evaluated to determine how quickly an area is increasing temperature. If there is a rise in temperature that is greater than a predefined threshold, the user interface 316 may provide feedback. This disclosure contemplates executing similar threshold comparisons and historical trend evaluations for the thermal data for the bale as well.

The feedback provided in box 412 may also alter the working conditions of the baler assembly 301 in one contemplated embodiment. For example, if any component or bale within the internal compartment provide thermal data that is outside of a threshold 312 or showing an undesirable trend in historical data 31 (such as rapid temperature increase), the evaluation system 308 may stop the baling operation. In this configuration, the evaluation system 308 may communicate with a baler control system that controls the baling operation. The baler control system may be part of the work machine or separate therefrom. Further, the evaluation system 308 may be part of the baler control system. Regardless, in one embodiment considered herein the evaluation control system 308 can alter the working conditions of the baler assembly 301 when the thermal data is outside of thresholds 312 or showing undesirable trends based on historical data 314.

In one aspect of this disclosure, when one of the thermal sensors 302 is a thermal camera the thermal data may include proximity of debris to a heated portion of the internal components. For example, the evaluation system 308 may analyze the temperature of the internal components and also use the provided thermal data to determine whether debris is adjacent to a heating portion of the internal components. If the evaluation system 308 identifies a heated internal component and debris positioned within a threshold distance therefrom, the evaluation system may provide feedback, which may include one or more of stopping the baling operation and sending feedback to the user via the user interface.

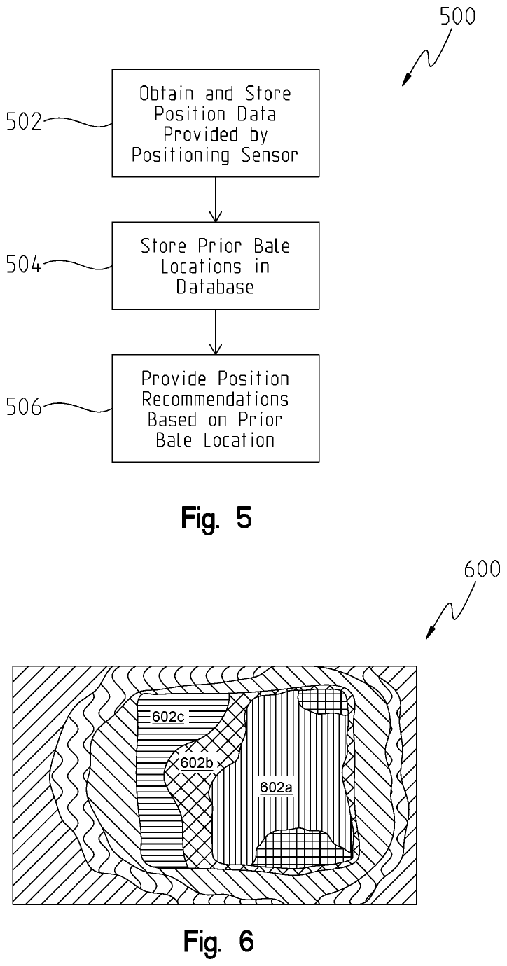

Referring now to FIG. 5, a bale location flow chart 500 is illustrated. In the bale location flow chart 500, the evaluation system 308 may obtain and store position data provided by the position sensor 306 in box 502. The position data may be stored on the priori map 324 in box 504 as a graphical representation of a bale in the particular geographic location in which it was distributed. The position data may be the geographic location of the baler assembly 301 at a particular time. Further, the positon data from the position sensor 306 may be stored in the historical data 314 of the database 310 every time a bale is ejected from the baler assembly 301 in box 502. In this configuration, the baler assembly 301 may maintain a record of the geographic location of each bale ejected therefrom in the historical data 314 which may also be represented in the priori map 324 in box 504. Alternatively, the baler assembly 301 may obtain bale position information from the work machine 170 or any other system that may be monitoring the geographic location of each bale.

Regardless of how the position data is generated or obtained, the evaluation system 308 may provide storage recommendations for the baler assembly 301 based on the historical data 314 for the bale locations. More specifically, the evaluation system 308 may consider the thermal data for the components in the internal compartment, along with the historical data, to determine whether the thermal data is indicating thermal conditions that should be considered prior to storing the baler assembly 301. The evaluations system 308 may identify the geographic location of bales within a field by referencing the priori map 324 and determine an offset from those bales for storing the baler assembly 301 that is appropriate given the thermal data from the internal compartment. When the baler assembly 301 is going to be parked or otherwise stored for a prolonged period of time, the evaluation system 308 may compare the current position of the baler assembly 301 identified by the position sensor 306 with the historical data 314 and priori map 324 providing the geographic locations of the ejected bales. The evaluation system 308 may then provide feedback to the user through the user interface 316 or otherwise if the baler assembly 301 is too close to an adjacent bale given the thermal data from the internal compartment.

The position recommendations from box 506 may also be stored or input data regarding the condition of the surrounding geographic location of the baler assembly 301. For example, if the geographic location of the baler assembly 301 provided by the position sensor 306 indicates the baler assembly 301 is in a known dry brush area when the baler assembly is being parked, the evaluation system 308 may reference the priori map 324 to identify the undesirable parking location and provide feedback to move the baler assembly 301 to a more suitable location to be parked. Similarly, the evaluation system 308 may provide user feedback when the positions sensor 306 is indicating the baler assembly 301 is being parked in a barn or other building when the thermal data of the internal compartment suggests an alternative parking location would be more suitable. In yet another embodiment contemplated herein, the position recommendations provided in box 506 may be the priori map 324 showing the current location of the baler assembly 301 along with approved parking locations. The user interface 316 may provide a visual representation of the priori map 324 that identifies parking location recommendations based on the known bale locations and conditions of the surrounding underlying surface.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for identifying thermal conditions of components of a baler assembly, comprising:
obtaining thermal data of an internal compartment of the baler assembly from a thermal sensor coupled to the baler assembly within the internal compartment;
evaluating the thermal data with an evaluation system to determine thermal properties of the internal compartment; and
providing a feedback when the thermal properties are outside of a thermal threshold.

2. The method of claim 1, wherein the thermal sensor comprises one or more of a thermal camera, an infrared sensor, a resistance temperature detector, a thermistor, or a semiconductor temperature sensor.

3. The method of claim 1, wherein the thermal sensor comprises a thermal camera.

4. The method of claim 1, further wherein the thermal data comprises data from a second thermal sensor spaced from the thermal sensor within the internal compartment;
wherein the second thermal sensor is spaced from the thermal sensor on an opposite side of the internal compartment and configured to provide thermal data for at least one internal component of the baler assembly on the opposite side of a bale when a bale is being formed therein.

5. The method of claim 1, further comprising storing the thermal data in a database as historical thermal data and identifying a thermal trend in the historical thermal data and generating a second feedback based on the thermal trend.

6. The method of claim 5, wherein the second feedback comprises a maintenance suggestion when the thermal trend is within a trend threshold.

7. The method of claim 1, wherein the feedback comprises an audio, visual, or sensory output.

8. The method of claim 7, further comprising providing the feedback through a user interface in a cab of a work machine.

9. The method of claim 1, further comprising providing the feedback when the baler assembly is transitioned to a parked configuration.

10. The method of claim 1, further comprising evaluating position data provided by a positioning sensor and providing position recommendations with the feedback.

11. The method of claim 10, further comprising considering prior bale locations before providing position recommendations.

12. The method of claim 1, wherein the thermal data comprises one or more of thermal properties for a roller and thermal properties for a bale.

13. The method of claim 1, wherein the thermal sensor is configured to detect the presence of a bale in the internal compartment.

14. The method of claim 13, wherein the feedback comprises stopping a baling procedure when the bale temperature data is outside of a bale temperature threshold.

15. The method of claim 1, wherein the thermal data comprises an image and the thermal threshold corresponds with colors in the image.

16. The method of claim 1, wherein the thermal data comprises temperature values.

17. A baler assembly, comprising:
a plurality of rollers spaced about an internal compartment and configured to form a bale therein; and
a thermal sensor positioned within the internal compartment and configured to provide thermal data for at least one internal component of the baler assembly to an evaluation system;
wherein, the thermal data is evaluated by the evaluation system to determine thermal properties of the internal compartment and provide a feedback when the thermal properties are outside of a thermal threshold.

18. The baler assembly of claim 17, wherein the thermal sensor comprises a thermal camera.

19. The baler assembly of claim 17, further comprising a user interface and the feedback is provided on the user interface.

20. The baler assembly of claim 17, further comprising a second thermal sensor configured to provide thermal data for at least one internal component of the baler assembly from a different perspective than the thermal sensor.
